(19) United States
(12) Patent Application Publication
(10) Pub. No.: US 2016/0333748 A1
(43) Pub. Date: Nov. 17, 2016

(54) METHOD AND A SYSTEM FOR DRIVING A TURBINE

(71) Applicant: ZAKLAD MECHANICZNY MESTIL SPOLK Z OGRANICZONA ODPOWIEDZIALNOSCIA, Gorzow Wlkp. (PL)

(72) Inventors: Zbigniew RUDOWICZ, Gorzow WIK. (PL); Jan WASKIEWICZ, Gorzow WIK. (PL); Wlodzimierz WOLOSZYNSKI, Gorzow WIK. (PL)

(21) Appl. No.: 15/114,855

(22) PCT Filed: Jan. 8, 2015
(86) PCT No.: PCT/PL2015/000003

§ 371 Date: Jul. 28, 2016

(30) Foreign Application Priority Data
Feb. 3, 2014 (PL) P.407056

(51) Int. Cl. F01K 27/00; H02K 7/18

(52) U.S. Cl. CPC F01K 27/005; H02K 7/1823

(57) ABSTRACT

In the method for driving a turbine according to the invention, at the moment of switching the direction of flow from the first tank (1) to the second tank (2) and at the moment of switching the direction of flow from the second tank (2) to the first tank (1), the liquid from the third tank (3) is displaced through the turbine (4). The controller (33) operating in conjunction with liquid level sensors (34, 35, 36, 37, 38, 39) is used by means of which steam valves (8, 9, 12, 13, 16, 17) and hydraulic valves (21, 22, 26, 27) are opened and closed, making possible the liquid flow direction to be switched from the first tank (1) to the second tank (2) and vice versa and making possible the liquid to be displaced from the third tank (3) through the turbine (4) to the selected first tank (2) or second tank (2). The turbine drive system according to the invention comprises the third tank (3) to which two pipes are led from the top: the steam supplying pipe (14) with the steam valve (16) and the steam evacuating pipe (15) with the steam valve (17). The pipe (28) is led from below to the bottom of the third tank (3), said pipe (28) supplying or evacuating the liquid depending on a stage of the turbine drive system operation. The pipe (28) is connected with an outlet of the check valve (30), an inlet of which is connected through the pipe (32) with the pipe (20), said pipe (20) being provided with the hydraulic valve (22) and being led to the bottom of the first tank (1). The first tank (1) is provided with two sensors (34, 35) of liquid level, the second tank (2) is provided with two sensors (36, 37) of liquid level and the third tank (3) is provided with two sensors (38, 39) of liquid level.

The subject of the present invention is the method and system for driving a turbine, intended to be used in power generating plants for driving a hydraulic turbine, wherein this turbine drives an electric generator.

The method for producing hydro-electric power is known from U.S. Pat. No. 5,461,858 patent. This method is embodied in a system comprising two cylindrical chambers connected with a steam power plant by means of pipes. These chambers are provided with steam valves at the points of those pipes entry to the cylindrical chambers. These cylindrical chambers are filled with water. Steam is alternately introduced to those cylindrical chambers, displacing water to a common reservoir and water from this common reservoir drives a Pelton wheel after which this water is introduced to the next cylindrical chamber. While one of cylindrical chambers is emptied of water under impact of steam, the second one is filled with water. The disadvantage of this solution is uneven flow of water through a Pelton wheel which occurs when emptying one cylindrical tank is switched into emptying the second tank.

From U.S. Pat. No. 5,865,086 patent, a thermo-hydro-dynamic system is known wherein a liquid tank is connected with two cylindrical tanks by means of pipes provided with valves, each of said tanks being equipped with upper and lower sensors of liquid level which are connected with a controller that controls opening and closing said valves. Water from the liquid tank is alternately introduced by gravity to cylindrical tanks. The system is equipped with a boiler in which steam is generated. Steam is supplied to cylindrical tanks alternately. When one of cylindrical tanks has been filled completely with water from the liquid tank, the controller opens the steam valve at the inlet through which steam is introduced to the cylindrical tank and opens the water valve allowing water to be removed from the tank. Introduced steam causes outflow of water from the cylindrical tank, wherein said water drives a turbine connected with an electrical generator. When one cylindrical tank is emptied of water, the second cylindrical tank is filled with water from the liquid tank. Both filling and emptying the cylindrical tanks occur alternately. When filling the cylindrical tank with water, steam from this tank is introduced to the boiler. The disadvantage of this solution is uneven flow of water through a turbine. When switching a direction of liquid flow between cylindrical water tanks a state occurs during which water does not flow through the turbine. This state is caused by the fact that the process of closing and opening the valves takes some time.

Free of described disadvantages is the method and the system for driving a turbine according to the invention, enabling even flow of liquid through a hydraulic turbine which drives an electrical generator.

The essence of the method for driving a turbine according to the invention is the fact that at the moment of switching the flow direction from the first tank to the second tank and at the moment of switching the flow direction from the second tank to the first tank liquid from the third tank is displaced thorough the turbine. The method comprises a controller operating in conjunction with liquid level sensors, which are installed in liquid tanks. By means of this controller steam and hydraulic valves are opened and closed, which enables switching the liquid flow direction from the first tank to the second tank and from the second tank to the first tank and enables displacing liquid from the third tank through the turbine to the selected first or second tank.

The essence of the turbine drive system according to the invention is the fact that it comprises an additional third tank to which two pipes are led from the top: a steam supply pipe with a steam valve and a steam evacuation pipe with a steam valve, whereas another pipe is led to the third tank bottom from below, through said pipe liquid being supplied or evacuated respectively, depending on a phase of turbine drive system operation. This pipe s connected with an outlet of a check valve, an inlet of which is connected through a pipe with a pipe provided with a hydraulic valve, the latter pipe being led to the bottom of the first tank, and with a pipe provided with a hydraulic valve, said pipe being led to the bottom of the second tank. The first tank is equipped with two sensors of liquid level, which are connected with the controller. The second tank is equipped with two sensors of liquid level, which are connected with the controller. The third tank is equipped with two sensors of liquid level, which are connected with the controller. Depending on a phase of system operation, the controller closes or opens steam and hydraulic valves, thus enabling liquid flow through the turbine from selected the first or the second tank and enabling simultaneous liquid flow through the turbine from the third tank jointly with liquid flow from selected the first or the second tank.

The advantage of the invention is elimination of uneven flow of liquid through a hydraulic turbine, wherein this turbine drives a generator. The invention makes possible low-temperature sources of heat to be used for production of steam from low boiling point liquids. It enables reduction of costs for electric energy production under conditions where a number of low-temperature sources of so called waste heat exist from which electric energy can be produced. The invention enables developing energy production from low-temperature geothermal sources, allows heat of exhaust gases in biomass incineration plants and biogas plants to be used, thus improving cost-effectiveness of those processes. The invention can be used wherever heat escapes to the atmosphere with hot exhaust gases.

The invention makes also possible electric energy to be produced wherever water is heated up for heating or utilizing purpose regardless of fuel type used or regardless of heat sourcing system, for example, when using solar collectors, in geothermics etc.

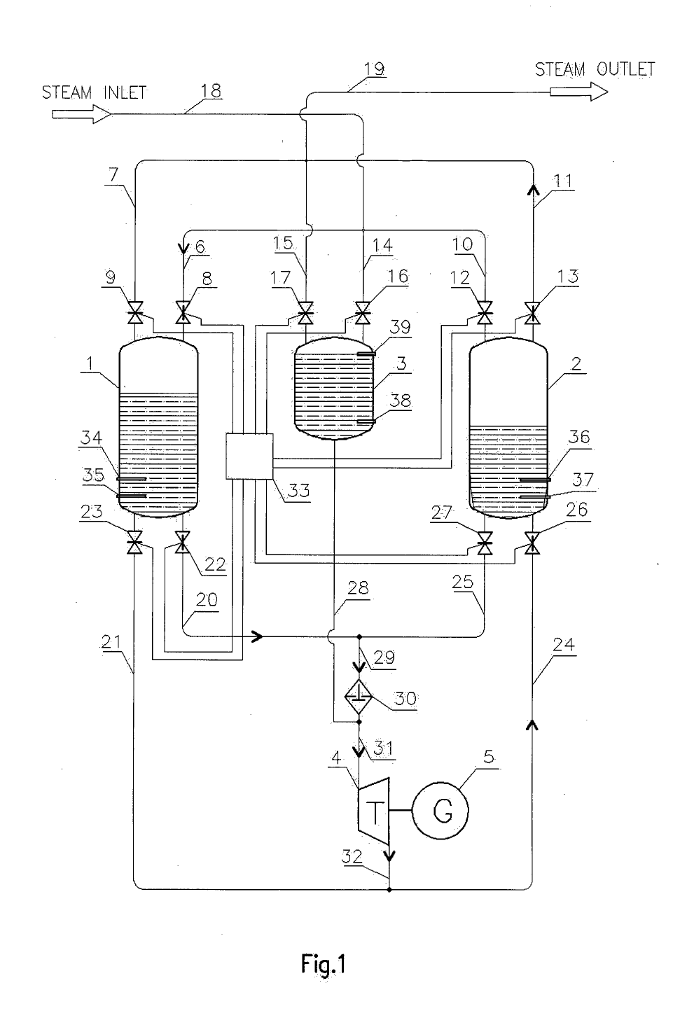

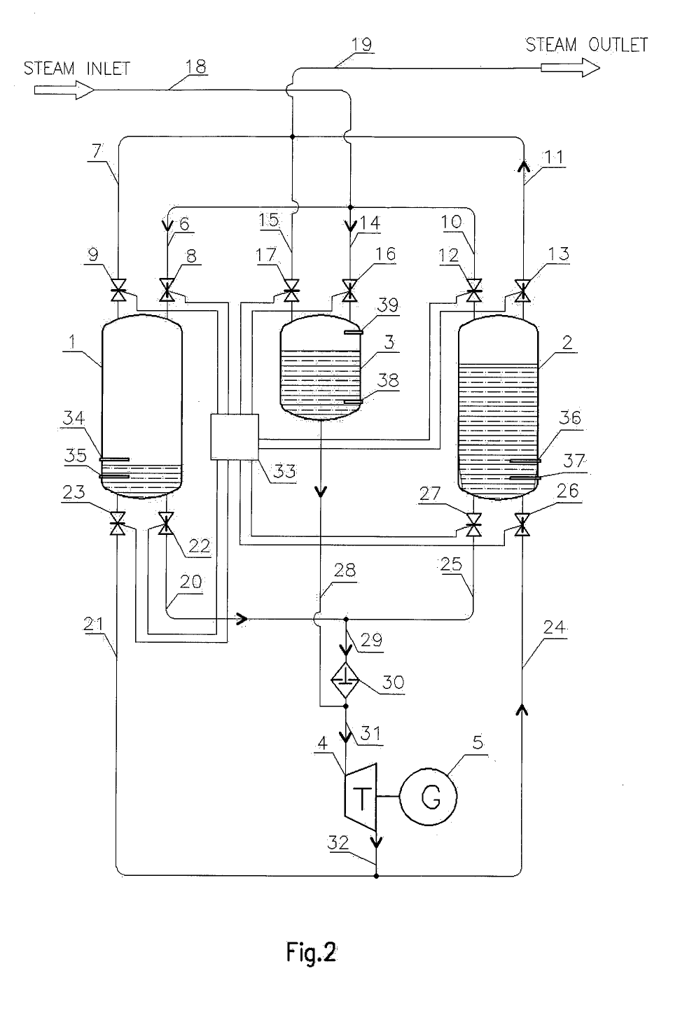

The invention has been explained based on the drawing which shows: in FIG. 1, the system with valving in state of displacing the liquid from the first tank to the second tank at the first stage of operation; in FIG. 2, the system with valving in state of simultaneous displacing the liquid from the first and third tank to the second tank at the second stage of operation; in

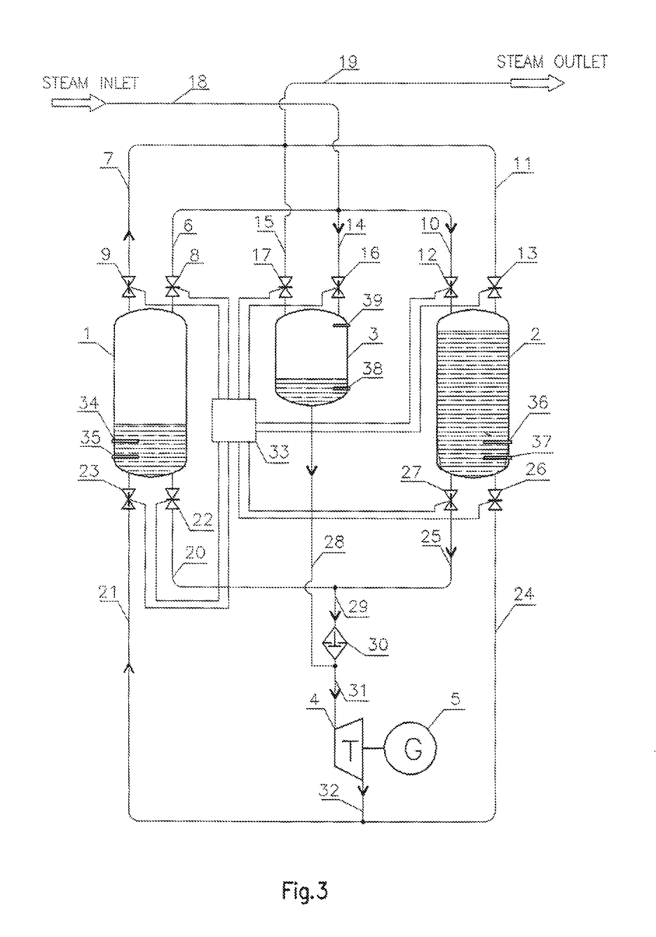

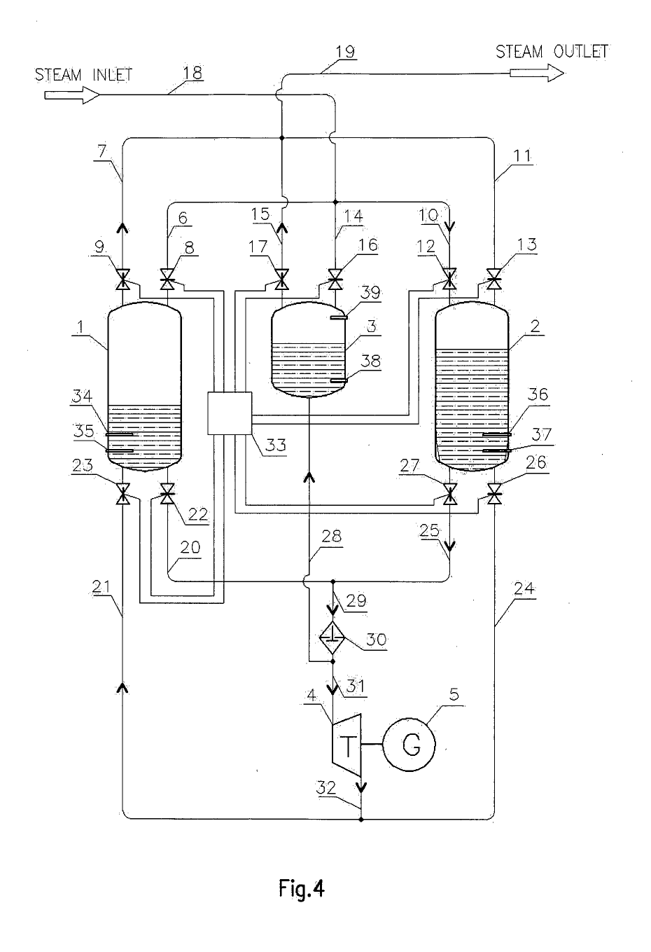

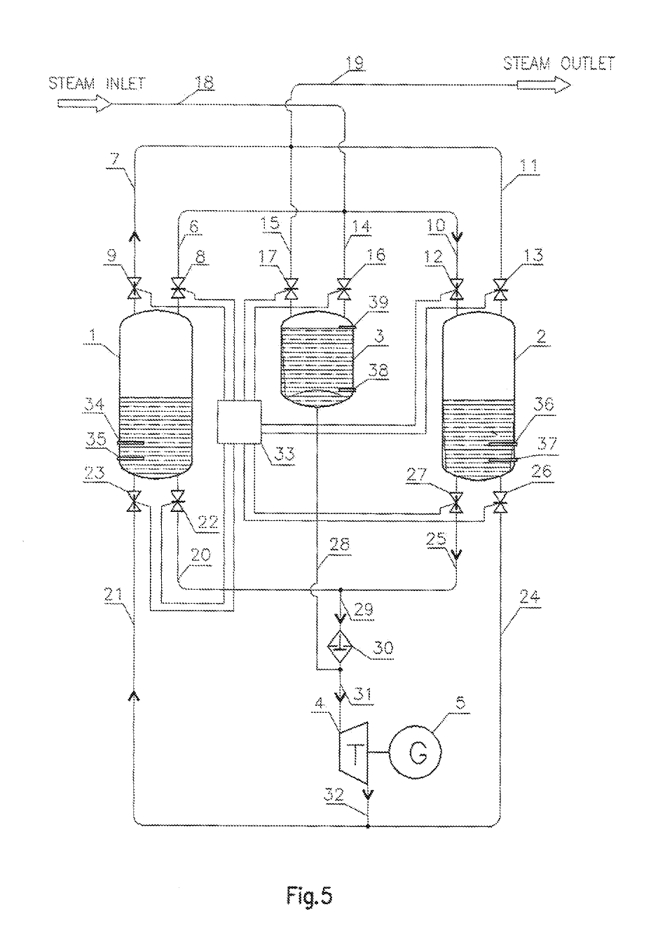

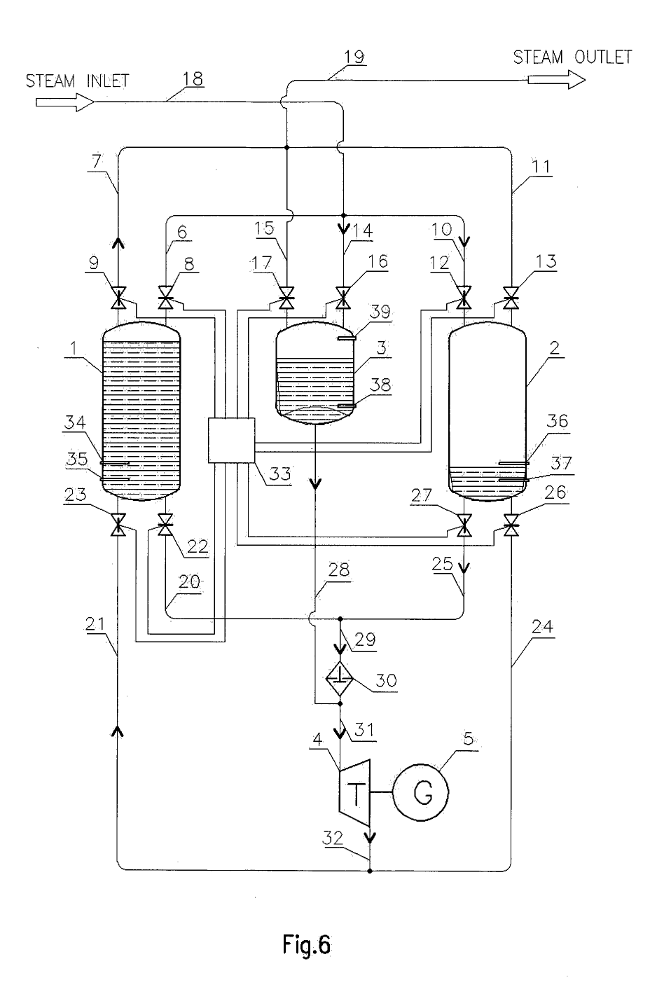

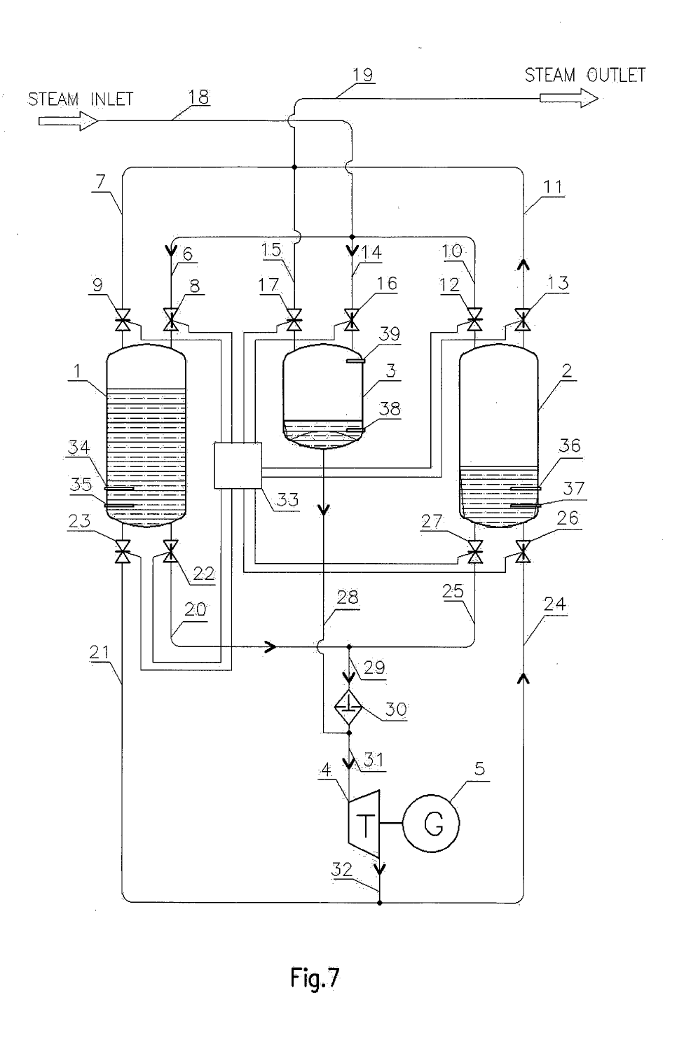

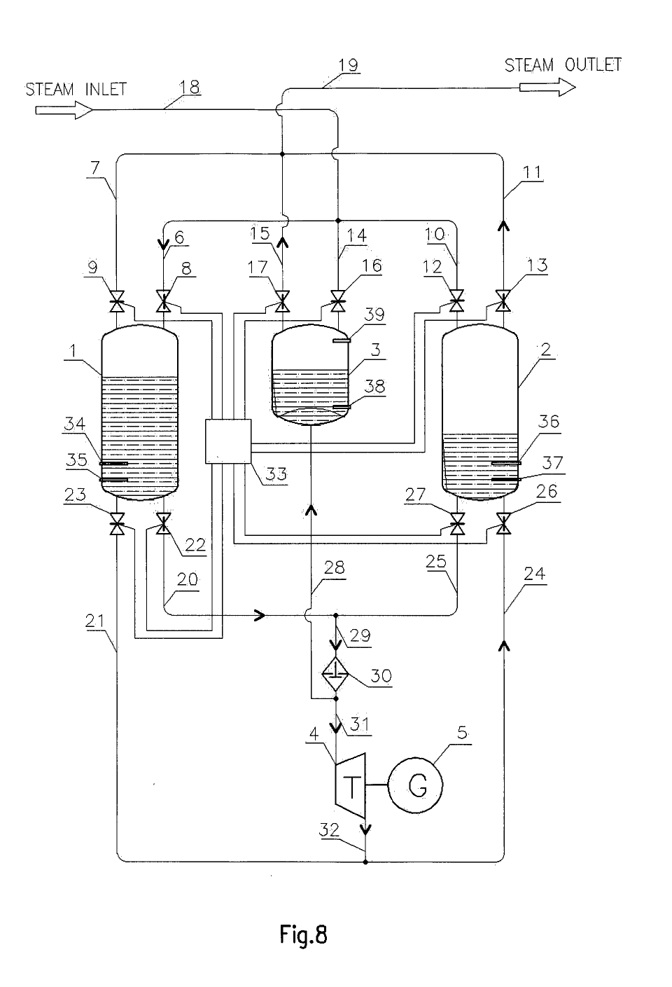

FIG. 3 the system with valving in state of simultaneous displacing the liquid from the second and third tank to the first tank at the third stage of operation; in FIG. 4, the system with valving in state of simultaneous displacing the liquid from the second tank to the first and third tank at the fourth stage of operation; in FIG. 5, the system with valving in state of displacing the liquid from the second tank to the first tank at the fifth stage of operation; in FIG. 6, the system with valving in state of simultaneous displacing the liquid from the second and third tank to the first tank at the sixth stage of operation; in FIG. 7, the system with valving in state of simultaneous displacing the liquid from the first and third tank to the second tank at the seventh stage of operation; in FIG. 8, the system with valving in state of simultaneous displacing the liquid from the first tank to the second and third tank at the eighth stage of operation.

The turbine drive system comprises three closed liquid tanks: tank 1, tank 2 and tank 3, and the turbine 4 which drives the generator 5. Two pipes, 6 and 7, of which the pipe 6 is used to supply the steam and the pipe 7 is used to evacuate the steam, are led from the top to the first tank 1. Close to the first tank 1, the pipe 6 is provided with the valve 8 and the pipe 7 is provided with the valve 9. Two pipes, 10 and 11, of which the pipe 10 is used to supply the steam and the pipe 11 is used to evacuate the steam, are led from the top to the second tank 2. Close to the second tank 2, the pipe 10 is provided with the valve 12 and the pipe 11 is provided with the valve 13. Two pipes, 14 and 15, of which the pipe 14 is used to supply the steam and the pipe 15 is used to evacuate the steam, are led from the top to the third tank 3. Close to the third tank 3, the pipe 14 is provided with the valve 16 and the pipe 15 is provided with the valve 17. Pipes 6, 10 and 14 are connected with the pipe 18 which supplies the steam from a steam source and pipes 7, 11 and 15 are connected with the pipe 19 which evacuates the steam. Two pipes, 20 and 21, of which the pipe 20 is used to evacuate the liquid and the pipe 21 is used to supply the liquid, are led from below to the first tank 1 bottom. Close to the first tank 1, the pipe 20 is provided with the valve 22 and the pipe 21 is provided with the valve 23. Two pipes, 24 and 25, of which the pipe 24 is used to supply the liquid and the pipe 25 is used to evacuate the liquid, are led from below to the second tank 2 bottom. Close to the second tank 2, the pipe 24 is provided with the valve 26 and the pipe 25 is provided with the valve 27. The pipe 28 through which, depending on a stage of the turbine drive system operation, the liquid is supplied or evacuated, is led from below to the third tank 3 bottom. Pipes 20 and 25 are connected with the pipe 29, said pipe 29 being connected to an inlet of the check valve 30. Two pipes are connected to an outlet of the check valve 30: the pipe 28, leading to the bottom of the third tank 3 and the pipe 31 which supplies liquid to the turbine 4. Pipes 21 and 24 are connected with the pipe 32, which evacuates the liquid from the turbine 4. Valves 8, 9, 12, 13, 16, 17 are steam valves and valves 22, 23, 26, 27 are hydraulic valves. All the valves 8, 9, 12, 13, 16, 17, 22, 23, 26, 27 are solenoid valves controlled by the controller 33 which operates in conjunction with liquid level sensors 34, 35, 36, 37, 38, 39.

The embodiment example comprises tanks 1 and 2 with 100 hl capacity each and the tank 3 with 10 hl capacity. The first tank 1 is provided with two liquid level sensors 34 and 35 connected with the controller 33, wherein the sensor 34 indicates reduction of the liquid level to 500 l and the sensor 35 indicates reduction of the liquid level to 100 l. The second tank 2 is provided with two liquid level sensors 36 and 37 connected with the controller 33, wherein the sensor 36 indicates reduction of the liquid level to 500 l and the sensor 37 indicates reduction of the liquid level to 100 l. The third tank 3 is provided with two liquid level sensors 38 and 39 connected with the controller 33, wherein the sensor 38 indicates reduction of the liquid level to 100 l and the sensor 39 indicates filling the tank with the liquid to the level corresponding to 900 l volume.

Before starting operation of the turbine drive system, 95 hl of the liquid is filled into the first tank 1 and 9 hl of the liquid into the third tank 3.

At the first stage of system operation, valves 9, 12, 16, 17, 23, 27 are closed and valves 8, 13, 22, 26 are open. At this stage of system operation, the liquid is displaced from the first tank 1 to the second tank 2. Under pressure of the steam introduced through the pipe 6 to the first tank 1, the liquid from the first tank 1 is supplied to the second tank 2 consecutively through the pipe 20, pipe 29, check valve 30, pipe 31, turbine 4, pipe 32 and pipe 24. The liquid level in the first tank 1 decreases, whereas in the second tank 2 the liquid level rises. The system with valving and steam and liquid flow in the state of the first stage are demonstrated in FIG. 1. Reduction of the liquid level in the first tank 1 to the level at which the liquid level sensor 34 is situated causes that connected with it the controller 33 opens the valve 16.

After opening the valve 16, the second stage of system operation occurs. The system with valving and steam and liquid flow in the state of the second stage are demonstrated in FIG. 2. The liquid continues to be displaced from the first tank 1 to the second tank 2. Under pressure of the steam introduced through the pipe 14 to the third tank 3, the liquid from this third tank 3 is displaced consecutively through the pipe 28, pipe 31, turbine 4, pipe 32 and pipe 24 to the second tank 2. At the second stage of system operation, the second tank 2 is supplied with the liquid flowing through the turbine 4 simultaneously from the first tank 1 and the third tank 3. Reduction of the liquid level in the first tank 1 to the level at which the liquid level sensor 35 is situated causes that connected with it the controller 33 opens the valves 9, 12, 23 and 27 and closes the valves 8, 13, 22 and 26.

Switching the status of valves 9, 12, 23, 27, 8, 13, 22 and 26 by the controller 33 introduces the system into the third stage. The system with valving and steam and liquid flow in the state of the third stage are demonstrated in FIG. 3. Under pressure of the steam, the liquid from the second tank 2 is displaced consecutively through the pipe 25, pipe 29, check valve 30, pipe 31, turbine 4, pipe 32 and pipe 21 to the first tank 1. At the same time, under pressure of the steam, the liquid from the third tank 3 is displaced consecutively through the pipe 28, pipe 31, turbine 4, pipe 32 and pipe 21 to the first tank 1. Displacing the liquid at the third stage lasts until the liquid level sensor 38 detects lack of the liquid in the third tank 3. Then, the controller 33, which is connected with the liquid level sensor 38, closes the valve 16 and opens the valve 17.

Switching the status of valves 16 and 17 by the controller 33 introduces the system into the forth stage. The system with valving and steam and liquid flow in the state of the forth stage are demonstrated in FIG. 4. Under pressure of the steam, the liquid from the second tank 2 is displaced consecutively through the pipe 25, pipe 29, check valve 30, pipe 31, turbine 4, pipe 32 and pipe 21 to the first tank 1. At the same time, under pressure of the steam, the liquid from the second tank 2 is displaced consecutively through the pipe 25, pipe 29, check valve 30, pipe 31, turbine 4, pipe 32 and pipe 21 to the third tank 3. Displacing the liquid at the forth stage lasts until the liquid level sensor 39 detects the tank 3 having been filled with the liquid to the volume of 900 I. Then, the controller 33, which is connected with the liquid level sensor 39, closes the valve 17.

Switching the status of the valve 17 by the controller 33 introduces the system into the fifth stage. The system with valving and steam and liquid flow in the state of the fifth stage are demonstrated in FIG. 5. Under pressure of the steam, the liquid from the second tank 2 is displaced consecutively through the pipe 25, pipe 29, check valve 30, pipe 31, turbine 4, pipe 32 and pipe 21 to the first tank 1. Reduction of the liquid level in the second tank 2 to the level at which the liquid level sensor 36 is situated causes that connected with it the controller 33 opens the valve 16.

After opening the valve 16, the sixth stage of system operation occurs. The system with valving and steam and liquid flow in the state of the sixth stage are demonstrated in FIG. 6. The liquid continues to be displaced from the second tank 2 to the first tank 1. Under pressure of the steam introduced through the pipe 14 to the third tank 3, the liquid from this third tank 3 is displaced consecutively through the pipe 28, pipe 31, turbine 4, pipe 32 and pipe 21 to the first tank 1. At the sixth stage of system operation, the first tank 1 is supplied with the liquid flowing through the turbine 4 simultaneously from the second tank 2 and the third tank 3. Reduction of the liquid level in the second tank 2 to the level at which the liquid level sensor 37 is situated causes that connected with it the controller 33 opens the valves 8, 13, 22 and 26 and closes the valves 9, 12, 23 and 27.

Switching the status of valves 8, 13, 22 i 26, 9, 12, 23 and 27 by the controller 33 introduces the system into the seventh stage. The system with valving and steam and liquid flow in the state of the seventh stage are demonstrated in FIG. 7. Under pressure of the steam, the liquid from the first tank 1 is displaced consecutively through the pipe 20, pipe 29, check valve 30, pipe 31, turbine 4, pipe 32 and pipe 24 to the second tank 2. At the same time, under pressure of the steam, the liquid from the third tank 3 is displaced consecutively through the pipe 28, pipe 31, turbine 4, pipe 32 and pipe 24 to the second tank 2. Displacing the liquid at the seventh stage lasts until the liquid level sensor 38 detects lack of the liquid in the third tank 3. Then, the controller 33, which is connected with the liquid level sensor 38, closes the valve 16 and opens the valve 17.

Switching the status of valves 16 and 17 by the controller 33 introduces the system into the eighth stage. The system with valving and steam and liquid flow in the state of the eighth stage are demonstrated in FIG. 8. Under pressure of the steam, the liquid from the first tank 1 is displaced consecutively through the pipe 20, pipe 29, check valve 30, pipe 31, turbine 4, pipe 32 and pipe 24 to the second tank 2. At the same time, under pressure of the steam, the liquid from the first tank 1 is displaced consecutively through the pipe 20, pipe 29, check valve 30 and pipe 28 to the third tank 3. Displacing the liquid at the eighth stage lasts until the liquid level sensor 39 detects the tank 3 having been filled with the liquid to the volume of 900 l. Then, the controller 33, which is connected with the liquid level sensor 39, closes the valve 17.

Switching the status of the valve 17 by the controller 33 introduces the system into the next stage, wherein the status of valves 8, 9, 12, 13, 16, 17, 22, 23, 26 and 27, steam flow route, liquid flow route and response of the controller 33 are identical as at the first stage. The operation cycle of the turbine drive system is continued repeatedly through consecutive stages.

Practical application of the invention makes possible OCR systems to be developed with the use of low boiling point liquids, commonly used in cooling installations, since it resolves a problem of very expensive and sophisticated steam and gas turbines, which are applied in those systems. The issue connected with those turbines is maintaining tightness of high-speed parts of a turbine, because vapours of low boiling point liquids are highly penetrating and very expensive special sealings are necessary to keep a system tight. Steam and gas turbines of prior art require relatively high pressures to make system operation effective. High-speed turbines require dry steam, since droplets of wet steam cause damage of turbine blades. Furthermore, these turbines operate ineffectively under variable conditions such as varying pressure and flow.

Application of the invention enables a system to be run effectively at low pressures of steam and completely eliminates a need of using very expensive sealings for rotating parts of gas and steam turbines, which are substituted by well known and relatively cheap hydraulic turbines, wherein penetrating vapours of low boiling point liquids and gases are separated from rotating parts of a turbine with the surface of liquid driving the turbine.

The invention enables also a system to be run effectively with the use of wet steam and when gas pressure and flow are varying.

To exert pressure on a liquid in tanks, a gas can be used instead of steam or vapour.

1. Accessory for shirts, consisting of a button (1), a flexible twisted pair (2), two sliders (3), which allows you keep open at a given distance, the neck of the shirt.

2. Accessory for shirts according to claim 1, characterized by the ability to engage the buttonhole (4) and the stud (5) of the collar of the shirt.

3. Accessory for shirts according to claim 1 characterized by a button (1) of varying shape whose dimensions are such as to prevent the passage of the button through the buttonhole of his shirt.

4. Accessory for shirts according to claim 1, characterized in that the button is connected with the two ends of the twisted pair (1).

5. Accessory for shirts according to claim 2, characterized in that the button and the twisted pair realize the coupling to the slot of the neck (4).

6. Accessory for shirts according to claim 1, characterized in that the loop of the twisted pair engages the collar-stud of the shirt (5).

7. Accessory for shirts according to claim 1, characterized in that the twisted pair, of given length, acts as a spacer between the stud and the slot of the neck.

8. Accessory coat according to claim 1, characterized by two sliders on the twisted pair (3).

9. Accessory coat according to claim 5, characterized in that the two sliders tighten the accessory towards the stud and towards the buttonhole (4), (5).
